(19) United States
(12) Patent Application Publication
(10) Pub. No.: US 2005/0139021 A1
(43) Pub. Date: Jun. 30, 2005

(54) Reciprocating mechanism

(75) Inventor: Sang Shuhua, Suzhou (CN)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(73) Assignee: Positec Powre Tools (Suzhou) Co., Ltd.

(21) Appl. No.: 11/019,004

(22) Filed: Dec. 21, 2004

(30) Foreign Application Priority Data
Dec. 29, 2003 (CN) 200320123658.9

(51) Int. Cl. F16H 21/16

(52) U.S. Cl. 74/49; 74/25

(57) ABSTRACT

The present invention relates to a reciprocating mechanism for a power tool comprising a reciprocating rod driven by a drive mechanism and a fixed elongate carrier member arranged to be slidably retained at least partially in or on the reciprocating rod. The carrier member permits intimate coupling of the drive mechanism and the reciprocating rod (and therefore lateral compactness) without comprising the effectiveness of the reciprocative action.

### FIELD OF THE INVENTION

The present invention relations to a reciprocating mechanism for a power tool.

### BACKGROUND OF THE INVENTION

Referring to FIG. 1, the prior art discloses a reciprocating mechanism for a power tool comprising a drive mechanism 10, a reciprocating shaft 100 driven by the drive mechanism 10 and support bearings 200 mounted on each face of the reciprocative movement is “b”. The bearings 200 must be positioned within the middle section “c” of the reciprocating shaft 100 (where “c”=“a”−“2b”) otherwise the reciprocating shaft 100 will disengage the bearings 200 during reciprocation. However, if the bearings 200 are too close to the middle of the reciprocating shaft 100, they will interfere with the drive mechanism 10. Alternatively, increasing the distance between the two bearings 200 will lead to a need for the reciprocating shaft 100 to be lengthened to avoid the bearing s200 dismounting during reciprocation. This will increase the overall size of the power tool which is not desirable. There is therefore a need to design a reciprocating mechanism for a power tool to overcome the disadvantages of the prior art.

### SUMMARY OF THE INVENTION

The main object of the present invention is to provide a compact (in particular a laterally compact) reciprocating mechanism which performs effective reciprocating movement.

The viewed from one aspect the present invention provides a reciprocating mechanism for a power tool comprising:
a reciprocating rod including an elongate retaining portion;
a drive mechanism arranged to drive the reciprocating rod;
a coupling mounted on the reciprocating rod for intimately coupling the drive mechanism and the reciprocating rod; and
a carrier assembly including:
a fixed elongate carrier member arranged to be slidably retained at least partially in or on the elongate retaining portion and a fixing block for fixing the elongate carrier member.

In order to accomplish the object, the present invention may provide a reciprocating mechanism which comprises a drive mechanism, a carrier assembly comprising a carrier member and a fixing block and a reciprocating rod comprising a retaining portion for receiving the carrier member and a coupling for connecting the drive mechanism and the reciprocating rod.

The present invention exploits a carrier assembly in place of bearings which permits intimate coupling of the drive mechanism and the reciprocating rod (and therefore lateral compactness) without compromising the effectiveness of the reciprocative action.

Preferably the elongate retaining portion is an elongate retaining channel and the elongate carrier member is arranged to be slidably retained at least partially in the elongate retaining channel.

Preferably the elongate carrier member is circularly columnar and the elongate retaining portion is a hollow guide bore and the elongate carrier member is arranged to a slidably retained at least partially in the hollow guide bore.

Preferably the coupling is mounted tangentially on the reciprocating rod.

Preferably the coupling is mounted transversely on the reciprocating rod.

Preferably the coupling is an elongate U-shaped coupling.

Preferably the coupling is mounted perpendicular to the axis of the reciprocating rod.

Preferably the fixing block is a terminal fixing block.

In a preferred embodiment, the reciprocating mechanism further comprises: a pin for penetrating the fixing block to fix the carrier assembly on a part of the power tool.

In a preferred embodiment, the reciprocating mechanism further comprises; a holding rack in the form of a U-shaped channel. Preferably the holding rack includes:
an elongate base terminating proximally in a positioning portion
a first side portion extending conterminously from a first longitudinal edge of the elongate base and
a second side portion extending conterminously from a second longitudinal edge of the elongate base,
wherein each of the first and second side portions extends into a platform rim.

Preferably the fixing block has a first hole and the positioning portion has a second hole, wherein the first hole and the second hole are coincident to receive the pin.

Preferably the drive mechanism includes a gear wheel with an eccentric axle bearing a sleeve, wherein the gear wheel is connected to the coupling via the sleeve. Preferably the gear wheel is transversely mounted.

Viewed from a further aspect the present invention provides a power tool comprising:
a shell;
a reciprocating mechanism as defined hereinbefore housed in the shell, wherein the elongate carrier member is fixed to the shell.

In a preferred embodiment, the power tool further comprises:
a saw blade which extends exteriorly to the shell and
a connecting device which connects the saw blade to the reciprocating mechanism to enable the saw blade to follow the movement of the reciprocating rod.

Viewed from a yet further aspect the present invention provides a reciprocating mechanism for a power tool comprising:
a driving mechanism;
a rail set comprising a guide channel for receiving the rail portion of the rail set and a connect portion for connecting to the driving mechanism.

Viewed from an even yet further aspect the present invention provides a power tool comprising:
a shell;
a driving mechanism; and
a reciprocating mechanism comprising:
a carrier assembly comprising a carrier portion and a fixing portion for engaging with the shell;
a reciprocating rod comprising a guide channel for receiving the carrier portion of the carrier assembly and a connect portion for connecting to the driving mechanism.

The reciprocating mechanism in accordance with the present invention may be used in a power tool. Preferably the power tool is a jigsaw or a reciprocating saw.

### BRIEF DESCRIPTION OF THE DRAWINGS

FIG. 1 shows a reciprocating mechanism of the prior art.

FIG. 2 shows a perspective exploded view of the reciprocating mechanism in accordance with an embodiment of the present invention.

FIG. 3 shows a front view of the reciprocating mechanism in accordance with an embodiment of the present invention.

FIG. 4 shows a cross-sectional view of the reciprocating mechanism in accordance with an embodiment of the present invention.

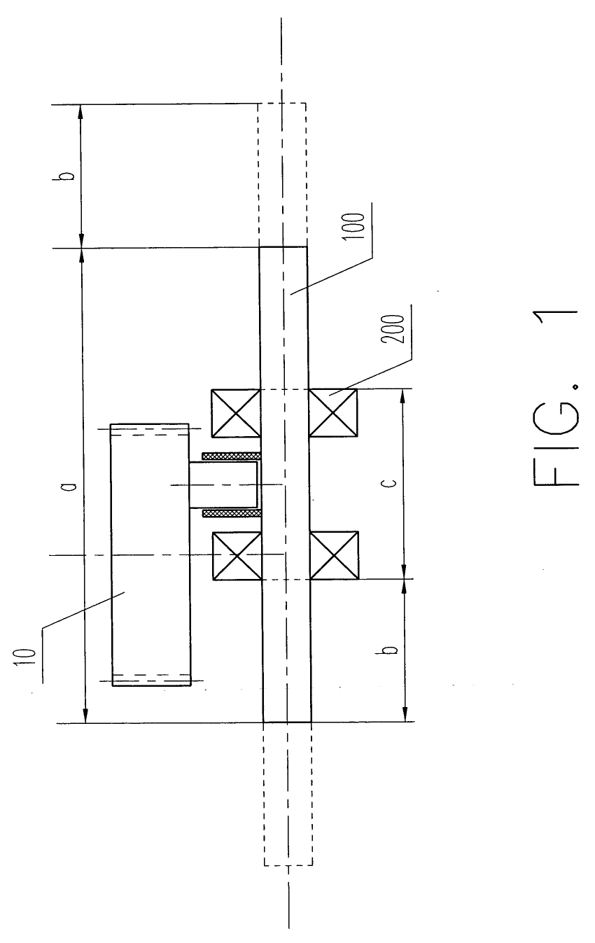

### DESCRIPTION OF THE PREFERRED EMBODIMENT

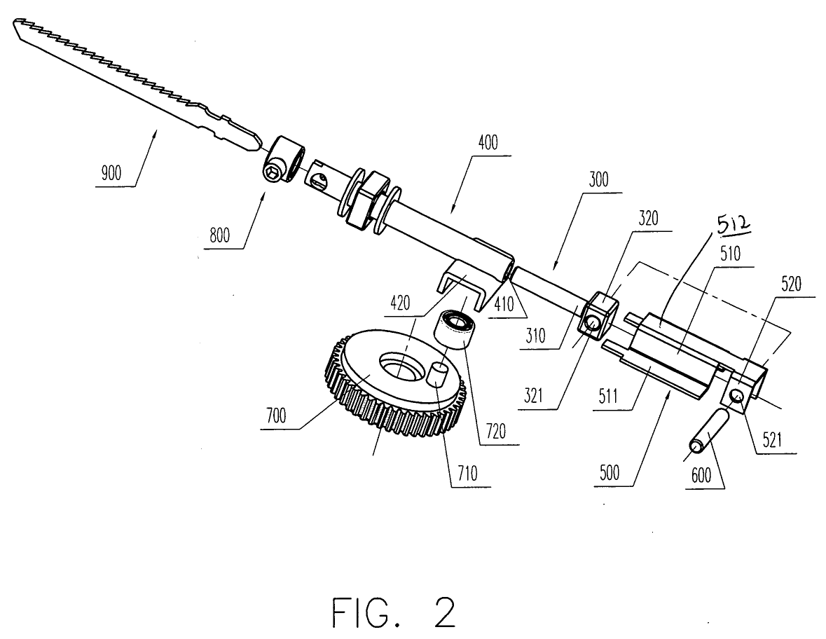

FIGS. 2 to 4 illustrate a jigsaw which comprises generally a shell 1, a reciprocating mechanism in accordance with an embodiment of the invention which is housed within the shell 1. The reciprocating mechanism comprises generally a carrier assembly 300, a reciprocating rod 400, a holding rack 500, a pin 600 for fixing the carrier assembly 300 and the holding rack 500 to the shell 1 and a drive mechanism. A connecting device 800 connects the saw blade 900 to the reciprocating mechanism to enable the saw blade 900 to follow the movement of the reciprocating rod 400 (described below).

The drive mechanism comprises a transverse gear wheel 700 with an eccentric axle 710 disposed on one face a sleeve 720 mounted on the eccentric axle 710.

The carrier assembly 300 comprises an elongate carrier member 310 which is circularly columnar and a terminal fixing block 320 which defines a fist hold 321 for receiving the pin 600.

The reciprocating rod 400 defines a hollow guide bore 410 for freely receiving the carrier member 310 so as to guide the reciprocating rod 400 during reciprocative movement. Mounted tangentially on the reciprocating rod 400 substantially perpendicular to the direction of reciprocation is an elongate U-shaped coupling 420 which serves to couple the reciprocating rod 400 with the sleeve 720.

The holding rack 500 is an elongate U-shaped channel comprising an elongate base 512 terminating proximally in a positioning portion 520 and two divergent side portions 510 extending conterminously from the longitudinal edges of the elongate base 512. Each side portion 510 extends into a platform rim 511. The positioning portion 520 defines a second hole 521 for receiving the pin 600.

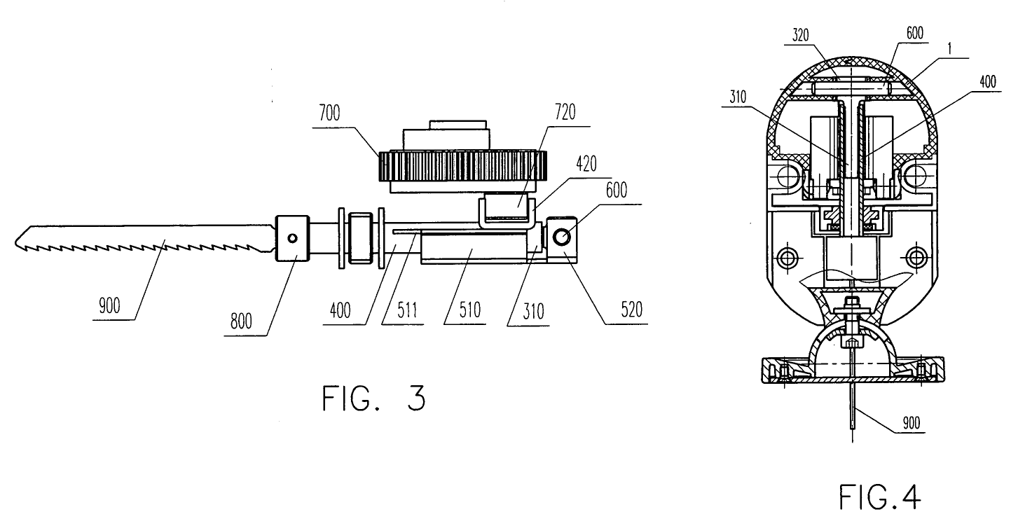

Referring to the reciprocating mechanism in assembled form illustrated in FIGS. 3 and 4, the pin 600 penetrates the first hold 321 and the second hole 521 and is fastened on the shell 1 to securely nest the carrier assembly 300 within the elongate U-shaped channel of the holding rack 500. Concomitantly, the elongate U-shaped coupling 420 is seated on each platform rim 511.

When the gear wheel 700 is powered by a rotary motor (not shown), the reciprocating rod 400 is driven reciprocatively (ie to-and-fro) causing the saw blade 900 to undergo a to-and-fro cutting action.

1. A reciprocating mechanism for a power tool comprising:
a reciprocating rod including an elongate retaining portion;
a drive mechanism arranged to drive the reciprocating rod;
a coupling mounted on the reciprocating rod for intimately coupling the drive mechanism and the reciprocating rod; and
a carrier assembly including:
a fixed elongate carrier member arranged to be slidably retained at least partially in or on the elongate retaining portion and
a fixing block for fixing the elongate carrier member.

2. The reciprocating mechanism of claim 1 wherein the elongate retaining portion is an elongate retaining channel and the elongate carrier member is arranged to be slidably retained at least partially in the elongate retaining channel.

3. The reciprocating mechanism of claim 1 wherein the elongate carrier member is circularly columnar and the elongate retaining portion is a hollow guide bore and the elongate carrier member is arranged to be slidably retained at least partially in the hollow guide bore.

4. The reciprocating mechanism of claim 1 wherein the coupling is mounted tangentially on the reciprocating rod.

5. The reciprocating mechanism of claim 1 wherein the coupling is mounted transversely on the reciprocating rod.

6. The reciprocating mechanism of claim 1, wherein the coupling is an elongate U-shaped coupling.

7. The reciprocating mechanism of claim 1, wherein the coupling is mounted perpendicular to the axis of the reciprocating rod.

8. The reciprocating mechanism of claim 1, wherein the fixing block is a terminal fixing block.

9. The reciprocating mechanism of claim 1 further comprising:
a pin for penetrating the fixing block to fix the carrier assembly on a part of the power tool.

10. The reciprocating mechanism of claim 1 further comprising:
a holding rack including:
an elongate base terminating proximally in a positioning portion
a first side portion extending conterminously from a first longitudinal edge of the elongate base,
wherein each of the first and second side portions extends into a platform rim.

11. The reciprocating mechanism of claim 10 wherein the platform rim is arranged to seat the coupling.

12. The reciprocating mechanism of claim 11 further comprising:
a pin for penetrating the fixing block to fix the carrier assembly on a part of the power tool and for penetrating the positioning portion so as to securely nest the carrier assembly within the holding rack.

13. The reciprocating mechanism of claim 12 wherein the fixing block has a first hole and the positioning portion has a second hole, wherein the first hole and the second hole are coincident to receive the pin.

14. The reciprocating mechanism of claim 1, wherein the drive mechanism includes a gear wheel with an eccentric axle bearing a sleeve, wherein the gear wheel is connected to the coupling via the sleeve.

15. A power tool comprising:
a shell;
a reciprocating mechanism as defined in claim 1 housed in the shell, wherein the elongate carrier member is fixed to the shell.

16. A power tool as claimed in claim 15 further comprising:
a saw blade which extends exteriorly to the shell and
a connecting device which connects the saw blade to the reciprocating mechanism to enable the saw blade to follow the movement of the reciprocating rod.
